(19) United States
(12) Patent Application Publication
(10) Pub. No.: US 2023/0032040 A1
(43) Pub. Date: Feb. 2, 2023

(54) SYSTEMS AND METHODS FOR SCENT EXPLORATION

(71) Applicant: ELC Management LLC, Melville, NY (US)

(72) Inventors: James Lamb, Hockessin, DE (US); Sowmya Gottipati, Marlboro, NJ (US); Kara Melillo, Long Island City, NY (US)

(21) Appl. No.: 17/874,226

(22) Filed: Jul. 26, 2022

Related U.S. Application Data
(60) Provisional application No. 63/227,922, filed on Jul. 30, 2021.

(51) Int. Cl. G06Q 30/06; G06V 40/16

(52) U.S. Cl. CPC G06Q 30/0631; G06V 40/174

(57) ABSTRACT

Systems and methods may deliver a personalized fragrance match to consumers based on fragrance testing, next-generation artificial intelligence, facial emotional recognition, and olfactory science. The brain's scent receptors may react to fragrance notes and ingredients, those reactions may be measured, and a custom profile may be created that pinpoints what the consumer loves to smell and predicts fragrances that the consumers may love. Using olfactory science, scent may be decoded by learning the precise receptors activated in the brain by any given fragrance, opening up immense potential for consumer facing implications. Though individual response to fragrance is subjective, the receptors being activated are not. Olfactory science enables “digitization” of fragrance, understanding the “receptor fingerprint” of any given fragrance. Accordingly, consumers may be matched to fragrances while emphasizing how the consumers want to feel when wearing the fragrance.

### CROSS-REFERENCE TO RELATED APPLICATION

The present application is a non-provisional of, and claims priority to, U.S. Patent Application No. 63/227,922 filed on Jul. 30, 2022, the disclosure of which is incorporated by reference in its entirety.

### FIELD OF THE DISCLOSURE

The present disclosure generally relates to scent exploration, and more particularly to systems and methods for scent exploration using fragrance trial, artificial intelligence, facial emotion recognition, and olfactive science.

### BACKGROUND

Currently, the fragrance industry has limited fragrance finder tools available to consumers. Fragrance finders today are largely quiz-oriented and limited to questions about the consumers known scent preferences. In the past few years, consumers have started to gravitate toward fragrances that make them feel a certain way (or convey a certain emotion) which has led to brands developing “personality quizzes” that then suggest fragrances based on the overall “vibe” the results convey. Some of the inherent issues with these types of fragrance finders include they are limited to what the consumer knows about fragrance and even themselves, they are limited to how detailed the personality quizzes are, and (most importantly), they infer that there is a direct correlation between personality type and the types of fragrances one will like. Discovering the perfect fragrance is far more complicated than simple quizzes surrounding preferences and “personality.”

### SUMMARY

Embodiments of the present disclosure may provide a next-generation fragrance finder that may include systems and methods for discovering fragrance using olfactory science, artificial intelligence, and physiological response. Systems and methods according to embodiments of the present disclosure may provide for measurement of physiological response (emotional response) of consumers when wearing/sampling various fragrances. By testing fragrances using systems and methods according to embodiments of the present disclosure, consumers may be able to uncover their own unique fragrance profile which may be made possible by converging what is known about the olfactory makeup of a given fragrance and how the consumer physiologically/emotionally responds when the receptors of a given fragrance are activated in his/her brain. Systems and methods according to embodiments of the present disclosure may measure emotion when sampling fragrances by measuring the consumer's physiological response based on his/her facial reactions. Accordingly, an accurate scent preference profile may be produced for consumers based on their reactions to fragrances and the scientific olfactory makeup of the fragrance(s) they test.

Additional embodiments of the present disclosure may provide a method for fragrance scent exploration comprising: using an interactive device, receiving a selection of a specified number of fragrances from a plurality of fragrances; prompting a consumer to experience a first fragrance of the specified number of fragrances, wherein while the consumer experiences the first fragrance, facial emotion recognition (FER) detection occurs through the interactive device to scan the consumer's facial expressions; providing a custom profile to the consumer after experiencing the first fragrance, the custom profile including how high of a match the first fragrance is for the consumer, percentages of each emotion felt by the consumer when using the first fragrance, and a graphical depiction of where the emotions fall on a scent category wheel; repeating the prompting and providing steps for each of the specified number of fragrances; and delivering a unique profile that recommends a fragrance that is right for the consumer based on emotion compatibility and olfactive family. The method may be presented through a native IOS application and/or through an in-store experience. The consumer may experience the first fragrance via a blotter card trial. The unique profile may include an olfactory wheel representing results of the specified number of fragrances experienced. The olfactory wheel may illustrate where each of the specified number of fragrances falls within the olfactory wheel based on top emotions evoked and a percentage match. The unique profile may identify a top three emotions evoked, percentage match, activated olfactory receptors, olfactory categories, hero ingredients, and fragrance recommendations. The method also may include providing additional information about emotional compatibility in the unique profile in response to an input by the consumer. The method may further include suggesting additional fragrances to the consumer, the additional fragrances identified based on a match with activated olfactory receptors in the recommended fragrance. The recommended fragrance may be provided based on collecting consumer emotion results through emotion sensing facial recognition and utilizing a consumer profile that has been created and sending that data to a scent finder application programming interface (API) and to a pre-process API FER which then may take subjective human data and objective OR data to evaluate fragrances within one or more databases to process through machine learning (ML) models to feed through the scent finder API.

### BRIEF DESCRIPTION OF THE DRAWINGS

For a more complete understanding of this disclosure, reference is now made to the following description, taken in conjunction with the accompanying drawings, in which:

FIG. 1 depicts a consumer experience flow according to an embodiment of the present disclosure;

FIG. 2 depicts a scent exploration process according to an embodiment of the present disclosure;

FIG. 3 depicts a high-level consumer experience flow according to an embodiment of the present disclosure;

FIG. 4 depicts EmotiScent ID results according to an embodiment of the present disclosure; and

FIG. 5 depicts a full-view technology mapping according to an embodiment of the present disclosure.

### DETAILED DESCRIPTION

Embodiments of the present disclosure may provide systems and methods to deliver a personalized fragrance match to consumers based on fragrance testing, next-generation artificial intelligence, facial emotional recognition, and olfactory science. The brain's scent receptors may react to fragrance notes and ingredients, those reactions may be measured, and a custom profile may be created that pinpoints what the consumer loves to smell and predicts fragrances that the consumers may love. Using olfactory science, scent may be decoded by learning the precise receptors activated in the brain by any given fragrance, opening up immense potential for consumer facing implications. Though individual response to fragrance is subjective, the receptors being activated are not. Olfactory science enables “digitization” of fragrance, understanding the “receptor fingerprint” of any given fragrance. Accordingly, consumers may be matched to fragrances while emphasizing how the consumers want to feel when wearing the fragrance.

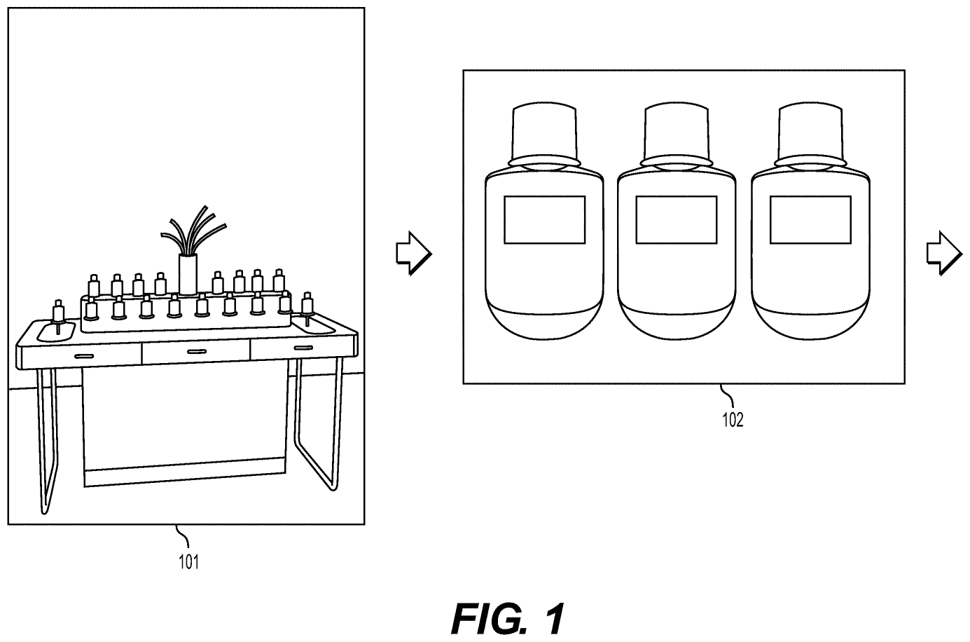

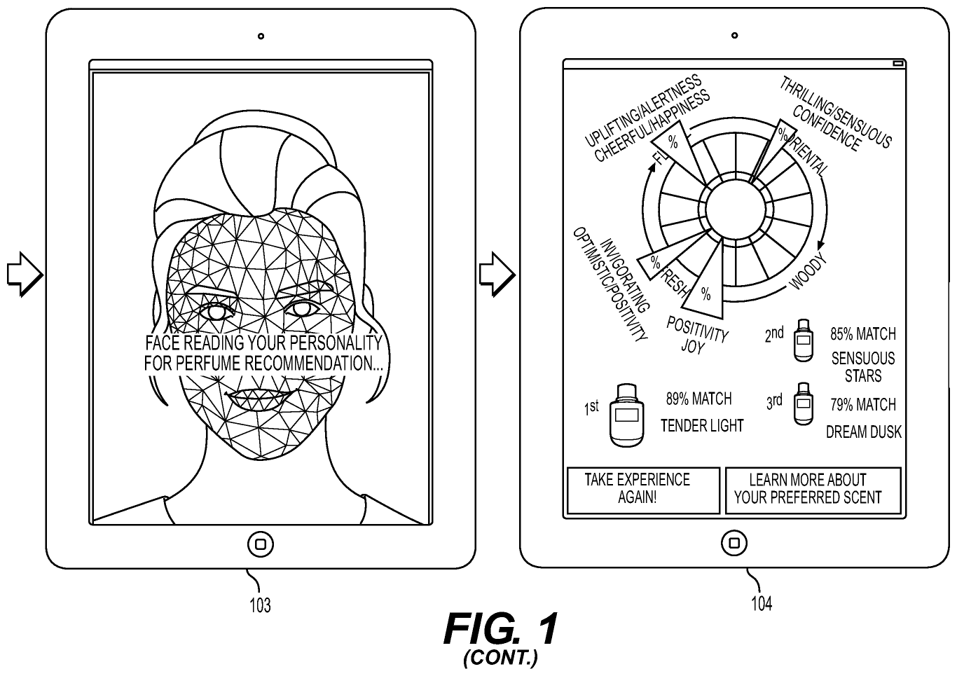

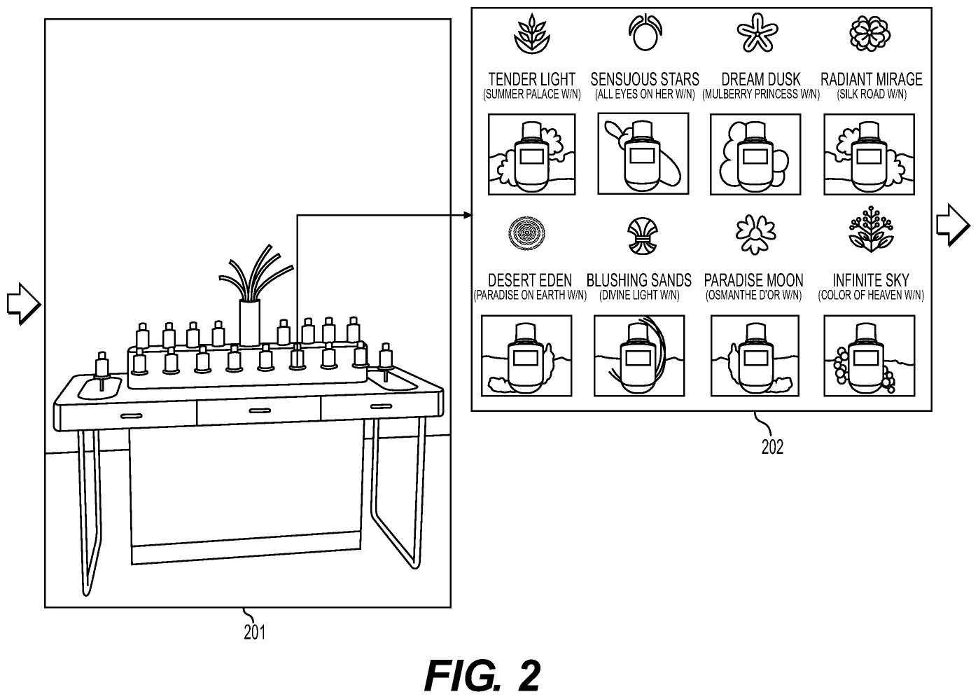

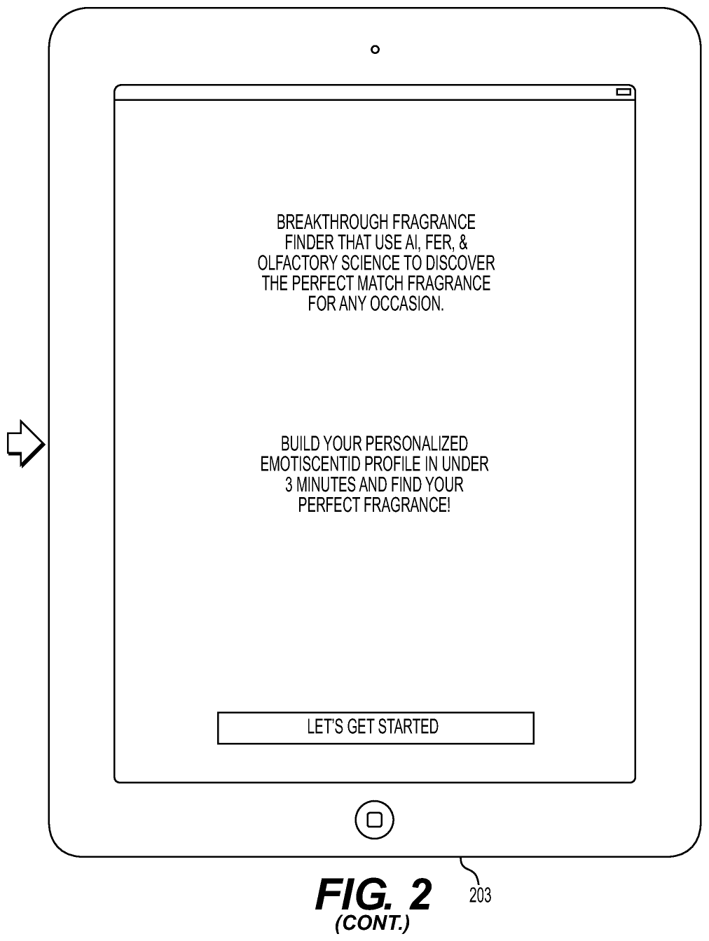

FIG. 1 depicts a consumer experience flow according to an embodiment of the present disclosure. FIG. 2 depicts a scent exploration process according to an embodiment of the present disclosure. An exploratory discovery table may be provided as a visual merchandising unit in a retail store to provide a physical location where a consumer may engage in scent exploration according to embodiments of the present disclosure (FIG. 1, step 101; FIG. 2). While some embodiments of the present disclosure are described in connection with a visual merchandising unit in a retail store, there may be embodiments of the present disclosure where a consumer may engage in scent exploration outside of the physical retail location. It should be appreciated that the scent exploration as described herein may be self-navigable or may be assisted in embodiments of the present disclosure. Regardless of whether self-navigated or assisted, the experience may include a blotter card trial as well as fragrance olfactive and ingredient storytelling.

In an embodiment of the present disclosure, a consumer may be prompted to select three fragrances from a plurality of fragrances that may be provided at the exploratory discovery table (FIG. 1, step 102; FIG. 2, 201, 202); however, a consumer may select (or be prompted to select) more or fewer fragrances without departing from the present disclosure. The consumer may bring the selected fragrances to a place where he/he may participate in the EmotiScent ID experience, as described in more detail herein. It should be appreciated that the EmotiScent ID experience may be presented to the consumer through a computer, tablet, handheld mobile device, or other similar interactive device in embodiments of the present disclosure. For example, the experience may be presented through a native IOS application, as an in-store experience, and/or as a white-label so that it may be ready for integration by a brand without departing from the present disclosure.

A landing page may be presented to the consumer on the interactive device to ground the consumer as to what his/her EmotiScent ID experience may entail (FIG. 2, 203). For example, the landing page may inform the consumer that the EmotiScent ID experience may provide a fragrance finder that uses artificial intelligence (AI), facial emotion recognition (FER), and olfactory science to discover the perfect match fragrance for any occasion. More specifically, AI may be used to learn emotional patterns of the consumer, connect emotion to activated OR receptors, and/or enable accurate EmotiScent ID profiles. Olfactory science may “digitize” the human scent, identify OR receptors in the brain, and/or enable fragrance fingerprinting, and emotion sensing FER may read facial expressions, decode emotional responses, and/or enable “emotion sensing.” A consumer also may be informed that he/she may build a personalized EmotiScent ID profile in under three minutes to find a perfect fragrance. However, the landing page may include additional or other language without departing from the present disclosure.

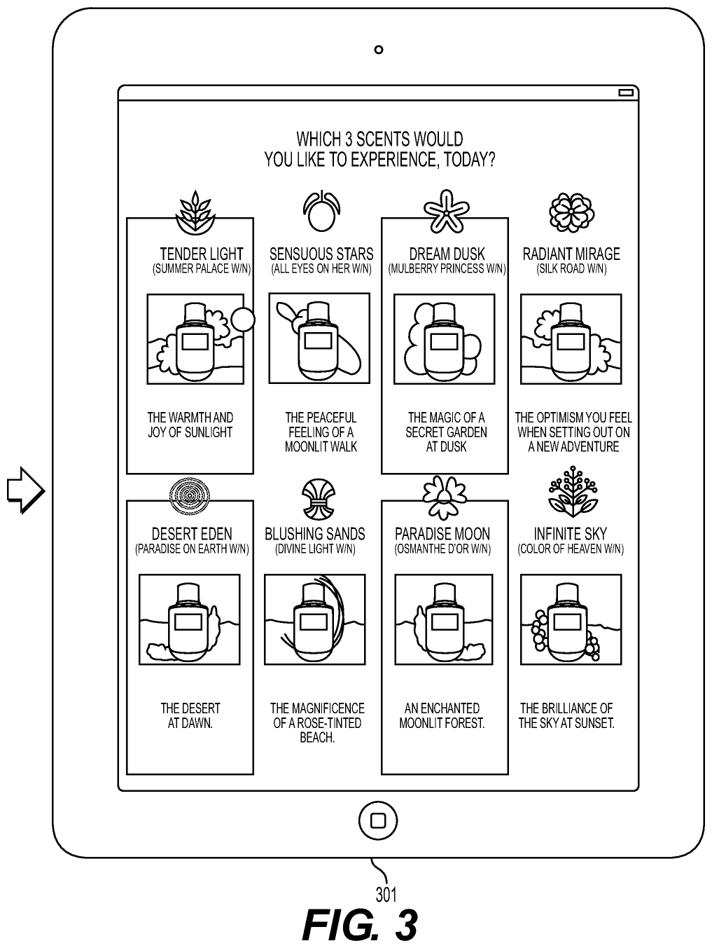

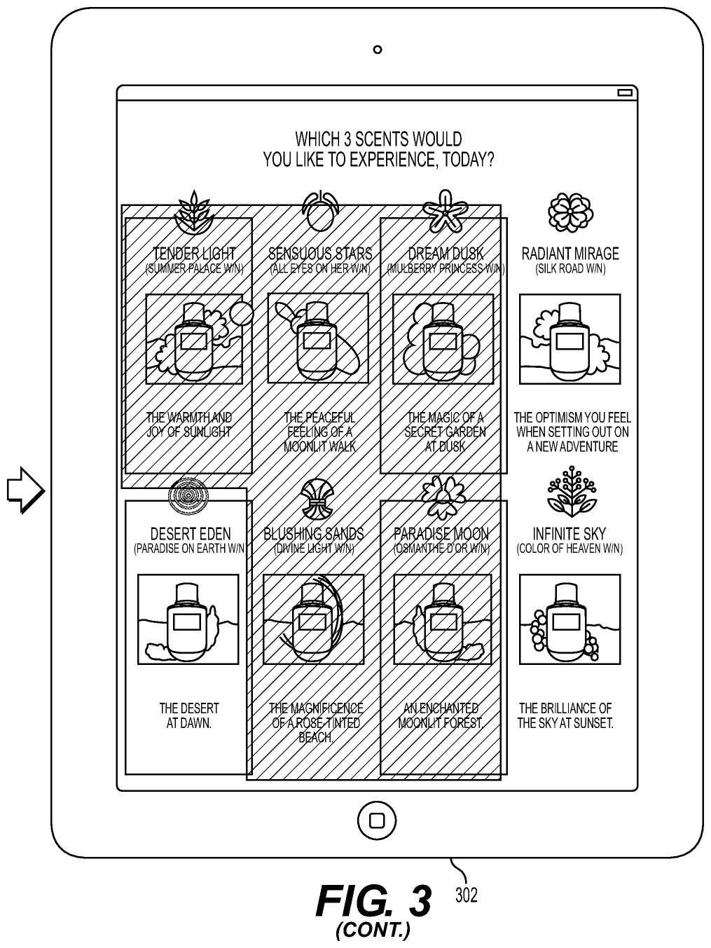

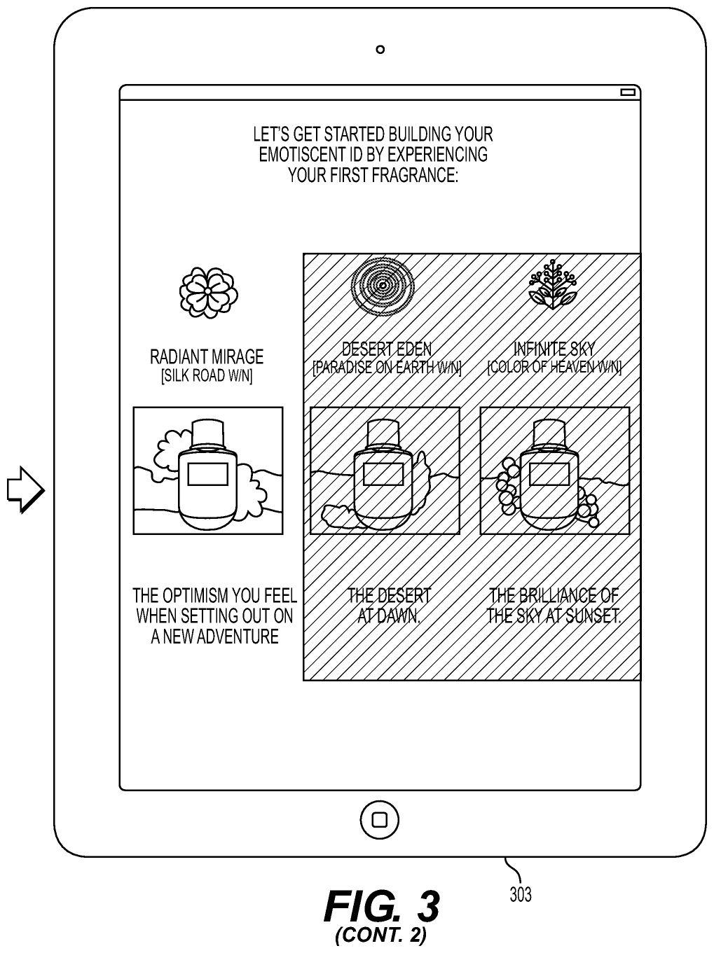

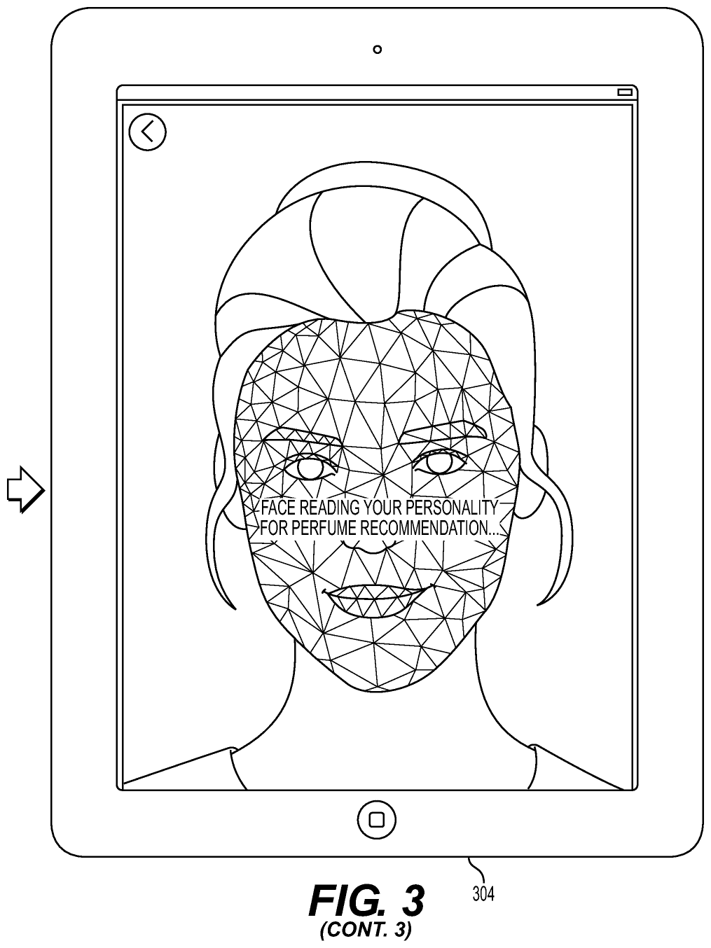

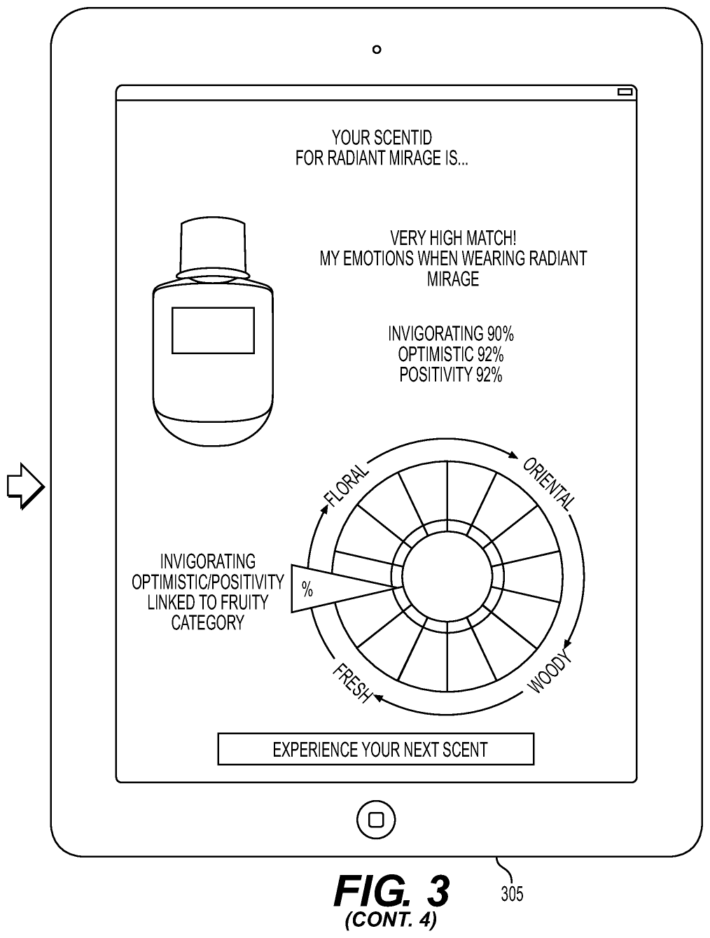

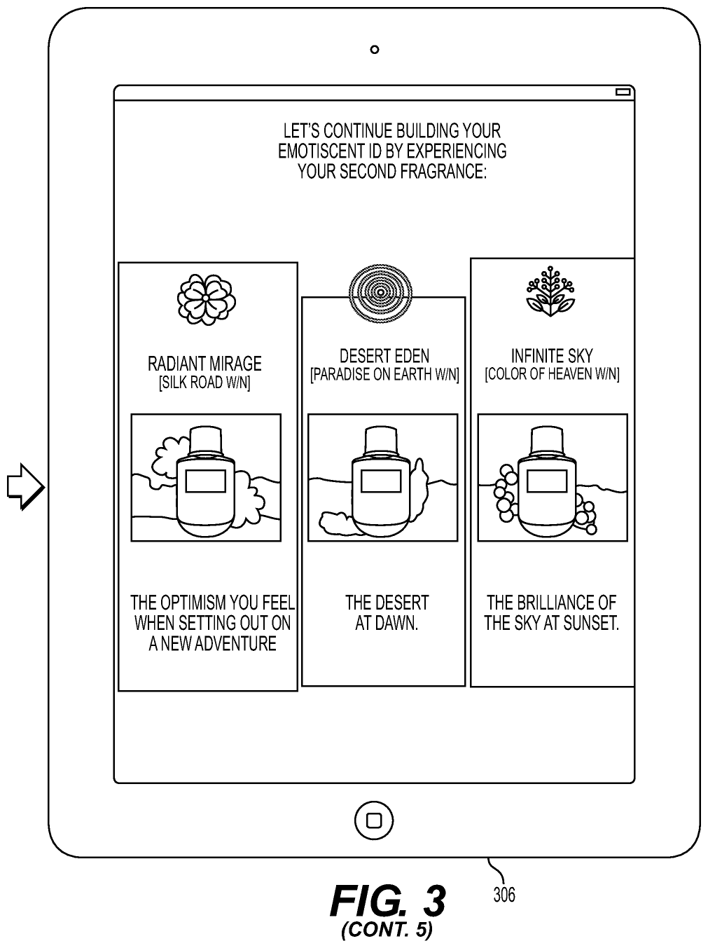

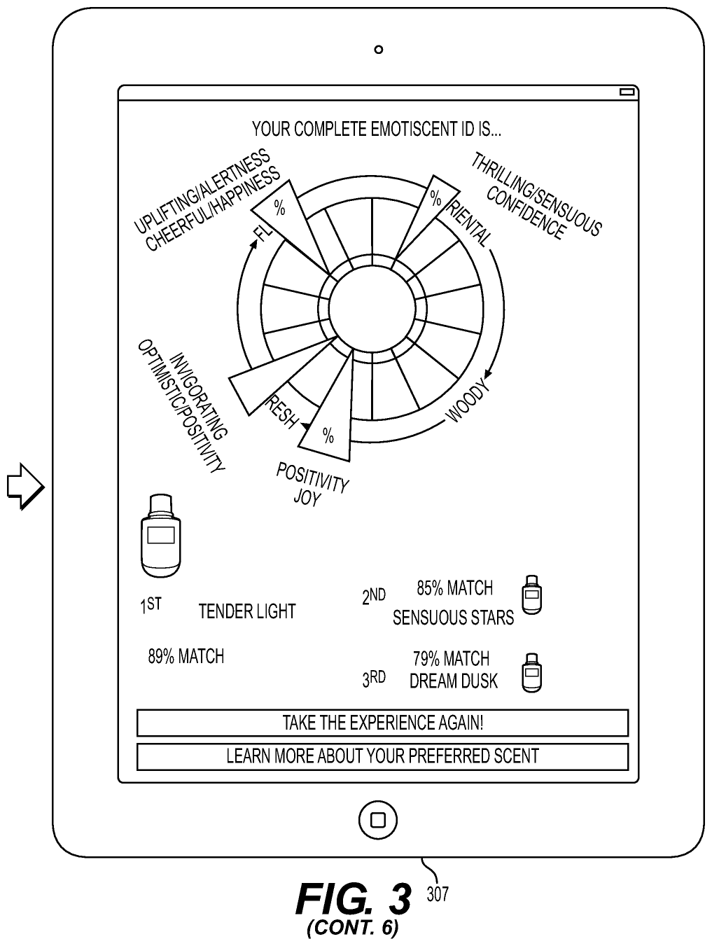

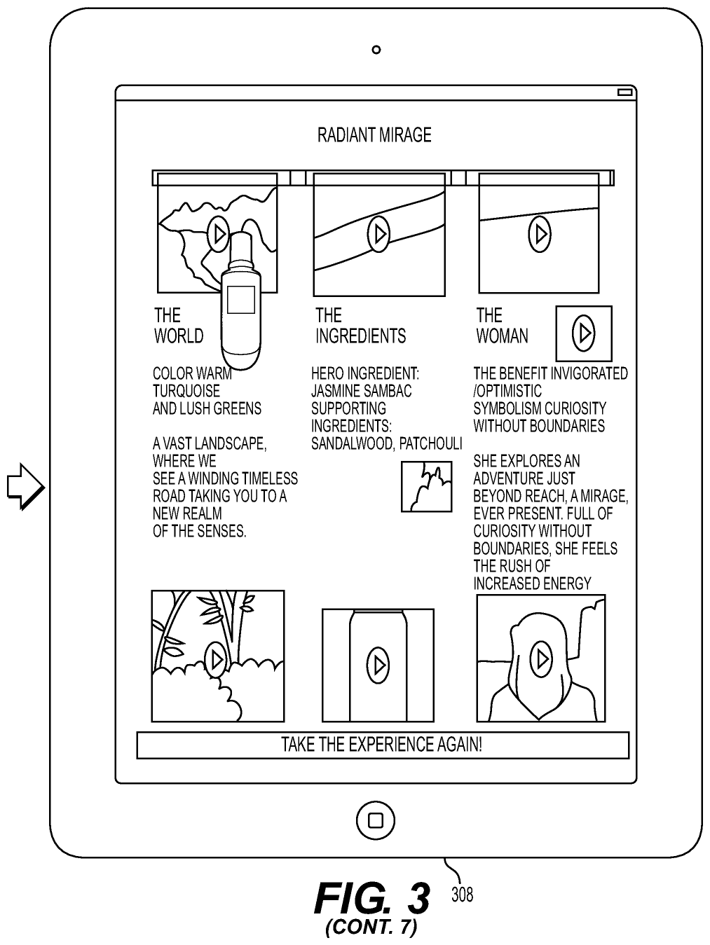

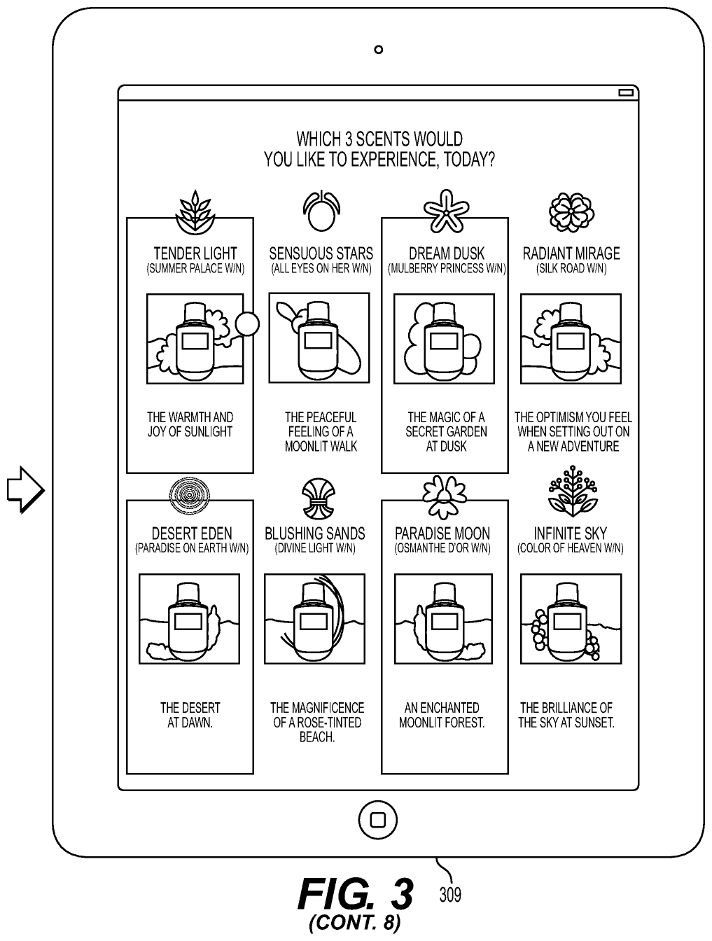

FIG. 3 depicts a high-level consumer experience flow according to an embodiment of the present disclosure. The consumer may then be prompted to begin the consultation by choosing the three (or more or fewer) fragrances that were selected at the exploratory discovery table (step 301). The consumer may be presented with icons and/or descriptions of each of the available fragrances, and the consumer may select his/her fragrances through an input mechanism, which may include, but is not limited to, his/her finger (such as with an interactive tablet), a mouse, and/or a keyboard. Upon selection, the selected fragrances may be highlighted on the display (step 302). The consumer may then be prompted to begin building his/her EmotiScent ID by experiencing the first fragrance (step 303). In some embodiments of the present disclosure, the consumer may be presented with the lightest scent of the selected fragrances first and move from the lightest to the deepest; however, there may be other embodiments of the present disclosure where the selected fragrances may be organized in a different manner.

While the consumer experiences each selected fragrance, facial emotion recognition (FER) detection may occur using the interactive device (FIG. 1, step 103). For example, the FER may prompt the consumer to experience the fragrance via a blotter card trial (FIG. 3, step 304). Directions to conduct such an experience may be provided on the display of the interactive device. While the consumer experiences the fragrance, the consumer's facial expressions may be scanned (FIG. 3, step 304).

After each trial of each selected fragrance, the consumer may receive a custom profile, which may be referred to as an EmotiScent ID herein, and the consumer also may see his/her profile being built through the experience of testing each selected fragrance (FIG. 3, step 305). As depicted herein, the consumer may be presented with information including, but not limited to, identification of how high of a match the selected fragrance is for the consumer, the percentages of each emotion that may be felt by the consumer when using the selected fragrance, and/or a graphical depiction of where the emotions fall on the scent category wheel. The EmotiScent ID may provide a scent preference fingerprint ascribed to a consumer who uses the fragrance finder described herein to sample fragrances. Accordingly, the consumer may learn what types of fragrances he/she gravitates toward based on desired emotional states. This EmotiScent ID also may equip the brand or provider of the fragrance(s) insights based on items including, but not limited to, region, demographics, interests, personality type, and/or emotional proclivities.

The consumer may then repeat the process with each additional selected fragrance to build his/her EmotiScent ID (FIG. 3, step 306). After the FER detection has occurred with respect to each fragrance that the consumer selected, the FER detections may be combined, and the EmotiScent ID may create a unique profile that pinpoints a consumer's ingredient preference, thereby recommending which fragrance is right for the consumer based on emotion compatibility and olfactive family (FIG. 1, step 104; FIG. 3, step 307). The consumer then may be prompted to learn more about the chosen fragrance (FIG. 3, step 308). Additionally, or alternatively, the consumer may start the experience over again to learn about other combinations of selected fragrances (FIG. 3, step 309). It should be appreciated that the more fragrances that the consumer tests, the more intelligent the consumer's EmotiScent ID may become.

The EmotiScent ID results as depicted in FIG. 3, step 307 may include, but are not limited to, an olfactory wheel that may represent the results of the fragrances that were sampled. This may illustrate where each of the selected fragrances fall within the wheel including, but not limited to, the top three emotions evoked and/or a percentage match. It should be appreciated that more or fewer emotions may be depicted and/or different ways of showing a match may be used without departing from the present disclosure. The results also may include an EmotiScent ID that may translate the results of the sampled fragrances into product recommendations from within one or more fragrance collections. The EmotiScent ID may include, but is not limited to, top three emotions evoked, percentage match, activated olfactory receptors, olfactory categories, hero ingredients, and/or fragrance recommendations. For example, a consumer may be provided with messaging for his/her EmotiScent ID that may state: “White Tea” in Fragrance 1 activates OR67 that evoked “Joy;” this OR67 is also activated by “Jasmine” from Fragrance 6 which gives Joy. Thereby we also recommend Fragrance 6. However, other messaging may be provided without departing from the present disclosure.

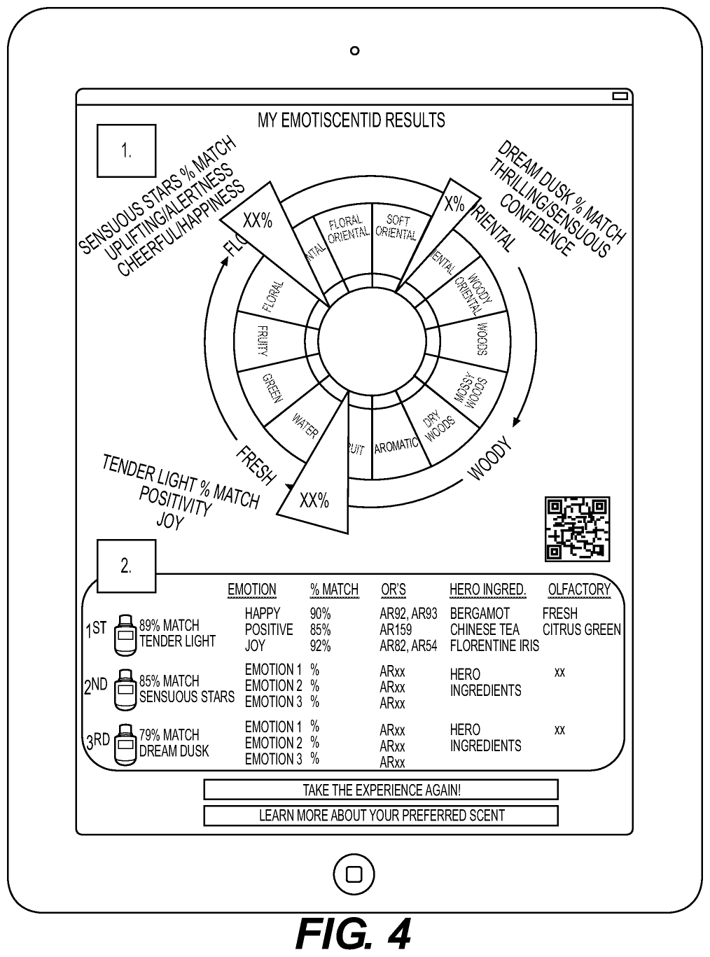

FIG. 4 depicts EmotiScent ID results according to an embodiment of the present disclosure. As depicted herein, the user may be presented with a percentage match with Tender Light having the detected emotions of positivity and joy. The consumer may click/hover on the detected emotions to see fragrance recommendations based on the desired emotional state. More specifically, the consumer may view the emotion results from each selected fragrance tested which may include the data points associated with the fragrances tested and the consumer's emotional results. It should be appreciated that while the top three fragrances may be presented in the EmotiScent ID based on the consumer's emotional response, other fragrances may be recommended to the consumer based on how the consumer wants to feel. For example, if the selected fragrance (such as Sensuous Stars) revealed that the consumer felt 88% confident, the consumer can then be presented with other fragrances from the scent finder that match the activated olfactory receptors in that selected fragrance.

While embodiments of the present disclosure have been described with respect to an in-store experience, it should be appreciated that the consumer journey may begin online in other embodiments of the present disclosure. The consumer may discover an application online or engage with the fragrance finder through use of a QR code. The consumer may then create a profile and learn about the fragrance finder, discover launch fragrances, and/or select his/her top emotions/feelings. The consumer's preferences may be captured, and a mood board may be created to capture personality and preferences associated with the consumer. The consumer may request samples such as through building a virtual fragrance vanity. This may allow the consumer to take a deeper dive into selected fragrances. The consumer may then test a fragrance through the application where graphical results may be displayed, and fragrances may be recommended for various emotions. The consumer results may be illustrated by cross-referencing the fragrance profile of the sampled fragrance(s) and the consumer's unique EmotiScent ID results. The consumer also may be provided with access to an online advisor and/or in-store appointment booking. The consumer may then make purchases of one or more fragrances.

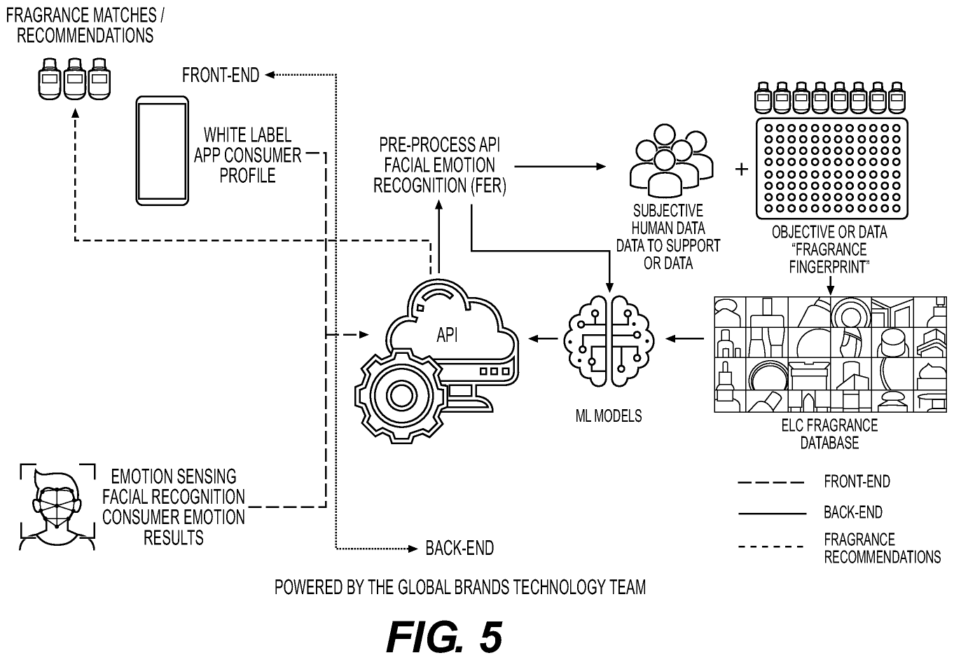

FIG. 5 depicts a full-view technology mapping according to an embodiment of the present disclosure. As depicted herein, fragrance matches/recommendations may be made by collecting consumer emotion results through emotion sensing facial recognition and/or utilizing the consumer profile that has been created and sending that data to a scent finder application programming interface (API) and to a pre-process API FER which may then take subjective human data (data to support OR data) and objective OR data (“fragrance footprint”) to evaluate fragrances within one or more databases to process through machine learning (ML) models to feed through the scent finder API.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for fragrance scent exploration comprising:
using an interactive device, receiving a selection of a specified number of fragrances from a plurality of fragrances;
prompting a consumer to experience a first fragrance of the specified number of fragrances, wherein while the consumer experiences the first fragrance, facial emotion recognition (FER) detection occurs through the interactive device to scan the consumer's facial expressions;
providing a custom profile to the consumer after experiencing the first fragrance, the custom profile including how high of a match the first fragrance is for the consumer, percentages of each emotion felt by the consumer when using the first fragrance, and a graphical depiction of where the emotions fall on a scent category wheel;
repeating the prompting and providing steps for each of the specified number of fragrances; and
delivering a unique profile that recommends a fragrance that is right for the consumer based on emotion compatibility and olfactive family.

2. The method of claim 1, wherein the method is presented through a native IOS application.

3. The method of claim 1, wherein the method is presented through an in-store experience.

4. The method of claim 1, wherein the consumer experiences the first fragrance via a blotter card trial.

5. The method of claim 1, wherein the unique profile includes an olfactory wheel representing results of the specified number of fragrances experienced.

6. The method of claim 5, wherein the olfactory wheel illustrates where each of the specified number of fragrances falls within the olfactory wheel based on top emotions evoked and a percentage match.

7. The method of claim 1, wherein the unique profile identifies a top three emotions evoked, percentage match, activated olfactory receptors, olfactory categories, hero ingredients, and fragrance recommendations.

8. The method of claim 1 further comprising:
providing additional information about emotional compatibility in the unique profile in response to an input by the consumer.

9. The method of claim 1 further comprising:
suggesting additional fragrances to the consumer, the additional fragrances identified based on a match with activated olfactory receptors in the recommended fragrance.

10. The method of claim 1, wherein the recommended fragrance is provided based on collecting consumer emotion results through emotion sensing facial recognition and utilizing a consumer profile that has been created and sending that data to a scent finder application programming interface (API) and to a pre-process API FER which then takes subjective human data and objective OR data to evaluate fragrances within one or more databases to process through machine learning (ML) models to feed through the scent finder API.
